(19) United States
(12) Patent Application Publication
(10) Pub. No.: US 2019/0161652 A1
(43) Pub. Date: May 30, 2019

(54) Method for producing an adhesive sealing tape

(71) Applicant: TESA SE, Norderstedt (DE)

(72) Inventors: Martin GEELINK, Hamburg (DE); Kerstin KLINGEBERG, Hamburg (DE)

(21) Appl. No.: 16/200,924

(22) Filed: Nov. 27, 2018

(30) Foreign Application Priority Data
Nov. 28, 2017 (DE) 10 2017 221 270.5

(51) Int. Cl. C09J 7/38; C09J 7/40

(52) U.S. Cl. CPC C09J 7/385; C09J 7/381; C09J 7/401; C09J 2475/005; C09J 2423/006; C09J 2433/00; C09J 2483/005; C09J 2423/00

(57) ABSTRACT

The aim is to provide an efficient method for producing a multi-layer adhesive tape having a heat-sealing layer and a pressure sensitive adhesive that results in effective composite adhesion of the individual layers to one another. This is accomplished with a method for producing an adhesive sealing tape covered with a release liner, said method comprising
a) heating a pressure-sensitive adhesive in such a way that the pressure-sensitive adhesive is present as a melt; and
b) producing a composite in a roll nip in such a way that
   a hotmelt adhesive layer is lying on one roll,
   a release liner is lying on the other roll, the release liner having an outer release layer, and this outer release layer pointing away from the roll surface,
   the pressure-sensitive adhesive melt is introduced into the roll nip and by rotation of the rolls, contacting of the layers and cooling, a composite is
   obtained with the sequence of hotmelt adhesive layer—pressure-sensitive adhesive—release liner,
the release liner remaining on the pressure-sensitive adhesive until the adhesive tape is applied.

The invention relates generally to the production of adhesive tapes of the kind used diversely for the temporary or long-term joining or masking of a multiplicity of substrates, such as of structural components. The invention relates more specifically to a method for producing an adhesive tape which comprises a hotmelt adhesive and a pressure-sensitive adhesive, the pressure-sensitive adhesive being applied from the melt to the hotmelt adhesive.

Adhesive tapes are generally furnished with adhesive on one or both sides. Using the tapes allows bonding to a range of substrates in a manner that is simple, quick and now also very powerful. The joining task involved is frequently one of uniting substrates that are very different in nature. In that case it can be advantageous to have an adhesive tape provided with adhesive on both sides, with the two adhesives having different properties.

Known, for example, are poly(meth)acrylate-based pressure-sensitive adhesives which produce high peel adhesion on a range of substrates and, moreover, are notable for the long-term stability of the adhesive bond under various external conditions.

Alternatively, heat-activatable adhesives have also come under the spotlight. These frequently comprise polyolefins, which in particular allow powerful bonds on both thermoplastic and thermoset substrates. In the case of thermoplastic substrates, not only the adhesive but also the substrate may be in a melted or softened state, and so the materials may penetrate one another superficially. This results in highly stable bonds after cooling; the substrate, so to speak, is “sealed”, and consequently such heat-activatable adhesives are also referred to as “sealing compounds” or “sealing layers”. In the case of thermoset substrates, the melted, heat-activated adhesive is able to wet the substrate very effectively, likewise resulting in high peel adhesion after cooling.

Double-sided adhesive tapes with different adhesives are described in EP 0 384 598 A1, for example. Specifically, the text discloses an adhesive tape having a layer comprising a heat-activatable polyolefin adhesive to which a polymer of selected acrylic monomers has been applied by means of graft polymerization. The adhesive tape further comprises a UV-polymerized, pressure-sensitive acrylate adhesive layer, which adheres to the heat-activatable layer even on exposure to heat.

A similar construction is described in U.S. Pat. No. 4,563,388 A.

EP 1 262 532 A1 describes an adhesive tape which comprises a heat-activatable adhesive layer based on a polymer of one or more olefin monomers, and a pressure-sensitive adhesive layer based on a pressure-sensitive polyacrylate adhesive. The pressure-sensitive adhesive layer is bonded directly and durably to the heat-activatable layer.

Against the background of the sustained demand for adhesive tapes based on hotmelt adhesive compounds and pressure-sensitive adhesive compounds (adhesive sealing tapes), there is great interest in methods for their efficient production. It is an object of the invention to provide an efficient method for producing a multi-layer adhesive tape having a heat-sealing layer and a pressure-sensitive adhesive, resulting in good composite adhesion of the individual layers to one another.

The achievement of the object is based on the idea of carrying out direct coating of sealing layer, pressure-sensitive adhesive melt and release liner. A first and general subject of the invention is therefore a method for producing an adhesive sealing tape covered with a release liner, said method comprising
a) heating a pressure-sensitive adhesive in such a way that the pressure-sensitive adhesive is present as a melt;
b) producing a composite in a roll nip in such a way that
   a hotmelt adhesive layer is lying on one roll,
   a release liner is lying on the other roll, the release liner having an outer release layer, and this outer release layer pointing away from the roll surface,
   the pressure-sensitive adhesive melt is introduced into the roll nip and
   by rotation of the rolls, contacting of the layers and cooling, a composite is obtained with the sequence of hotmelt adhesive layer—pressure-sensitive adhesive—release liner,
the release liner remaining on the pressure-sensitive adhesive until the adhesive tape is applied.

A method of the invention affords, in particular, adhesive sealing tapes with high composite adhesion, this being manifested in fracture within the pressure-sensitive adhesive layer or within the bondline between pressure-sensitive adhesive and substrate when a bond produced with the adhesive sealing tape is loaded correspondingly. Moreover, the method allows a saving to be made in terms of the two laminating steps for applying the release liner and the sealing layer, thereby also saving on the energy required for those steps and on the necessary additional materials, such as for example a process liner or auxiliary liner for carrying the pressure-sensitive adhesive layer.

An “adhesive sealing tape” in accordance with the invention is an adhesive tape which on the one hand, via a layer of pressure-sensitive adhesive, develops peel adhesion to one of the parts to be joined to one another and on the other hand—after appropriate heating—develops peel adhesion to the other of the parts to be joined to one another, by way of a hotmelt adhesive layer (thermoplastic sealing layer).

In accordance with the invention, and as customary in the general linguistic usage, a pressure-sensitive adhesive (PSA) is understood to be a substance which at least at room temperature is durably tacky and also adhesive. Characteristic of a PSA is that it can be applied to a substrate by means of pressure, and remains adhering there, with the pressure to be employed and the duration of that pressure not being defined in more detail. Generally speaking, though fundamentally dependent on the precise nature of the PSA, the temperature and the atmospheric humidity, and of the substrate, a minimal pressure acting for a short time, which does not go beyond gentle contact for a brief moment, is sufficient to obtain the adhesion effect; in other cases, a longer-term duration of exposure to a higher pressure may also be necessary.

PSAs have particular, characteristic viscoelastic properties which result in the durable tack and adhesiveness. Characteristically, when PSAs are mechanically deformed, there are viscous flow processes and there is also development of elastic restorative forces. In terms of their respective proportion, the two processes are in a particular relationship with one another, dependent not only on the precise composition, structure and degree of crosslinking of the PSA but also on the rate and duration of the deformation, and on the temperature.

The proportional viscous flow is necessary for the achievement of adhesion. Only the viscous components, produced by macromolecules with relatively high mobility, allow effective wetting and effective flow onto the substrate to be bonded. A high viscous flow component results in high pressure-sensitive adhesiveness (also referred to as tack or surface tackiness) and hence often also in a high peel adhesion. Owing to a lack of flowable components, highly crosslinked systems and polymers which are crystalline or which have undergone glasslike solidification generally have at least only a little tack, or none at all.

The proportional elastic restorative forces are necessary for the achievement of cohesion. They are brought about, for example, by very long-chain, highly entangled macromolecules and also by physically or chemically crosslinked macromolecules, and they permit the transmission of the forces engaging on an adhesive bond. Their result is that an adhesive bond is able to withstand sufficiently over a prolonged time period a long-term load acting on it, in the form for example of a sustained shearing load.

For more precise description and quantification of the extent of elastic and viscous components, and also of the proportion of the components to one another, the variables of storage modulus (G′) and loss modulus (G″) are employed, and can be determined by Dynamic Mechanical Analysis (DMA). G′ is a measure of the elastic fraction, G″ a measure of the viscous fraction, of a substance. Both variables are dependent on the deformation frequency and the temperature.

The variables can be determined by means of a rheometer. In this case, the material for analysis is exposed to a sinusoidally oscillating shearing stress in—for example—a plate/plate arrangement. In the case of instruments operating with shear stress control, measurements are made of the deformation as a function of time, and of the time offset of that deformation relative to the introduction of the shearing stress. This time offset is identified as phase angle δ.

The storage modulus G′ is defined as follows: G′=(τ/γ)*cos(δ) (τ=shearing stress, γ=deformation, δ=phase angle=phase shift between shear stress vector and deformation vector). The definition of the loss modulus G″ is as follows: G″=(τ/γ)*sin(δ) (τ=shearing stress, γ=deformation, δ=phase angle=phase shift between shear stress vector and deformation vector).

A composition is considered in general to be a PSA and is defined as such for the purposes of the invention if at 23° C. in the deformation frequency range from 10⁰ to 10¹ rad/sec, both G′ and G″ are situated at least partly in the range from 10³ to 10⁷ Pa. “Partly” means that at least a section of the G′ plot is within the window subtended by the deformation frequency range of from 10⁰ (inclusive) to 10¹ (inclusive) rad/sec (abscissa) and also the range of the G′ values from 10³ (inclusive) to 10⁷ (inclusive) Pa (ordinate) and when at least a section of the G″ plot is likewise within the corresponding window.

The material basis for the PSA is fundamentally arbitrary, provided that the procedure of the invention, and the compatibility with the hotmelt adhesive layer, are ensured.

The PSA preferably comprises poly(meth)acrylate to an extent of at least 30, more preferably at least 40, more particularly at least 50 wt %. By “poly(meth)acrylate” is meant a polymer whose monomer basis consists to an extent of in total at least 50 wt % of acrylic acid, methacrylic acid, acrylic esters and/or methacrylic esters, with acrylic esters and/or methacrylic esters being present at in total at least 30 wt %, based in each case on the overall monomer composition of the polymer in question. Poly(meth)acrylates are obtainable generally by radical polymerization of acrylic and/or methylacrylic monomers and also, optionally, other copolymerizable monomers. In accordance with the invention, the term “poly(meth)acrylate” embraces not only polymers based on acrylic acid and derivatives thereof but also those based on acrylic acid and methacrylic acid and derivatives thereof, and polymers based on methacrylic acid and derivatives thereof. The PSA may comprise one or more poly(meth)acrylates.

A poly(meth)acrylate-based PSA has advantageously high peel adhesion relative to a range of substrates, and is notable, moreover, for high stability towards environmental influences and also over long periods of time.

The poly(meth)acrylate of the PSA may preferably be traced back to the following monomer composition:
a) acrylic esters and/or methacrylic esters of the formula (I)

CH₂═C(R^{I})(COOR^{II}) (I),
in which R^{I} is H or CH₃ and R^{II} is an alkyl radical having 4 to 14 C atoms, more preferably having 4 to 9 C atoms;
b) olefinically unsaturated monomers having functional groups which exhibit reactivity with crosslinker substances;
c) optionally further olefinically unsaturated monomers which are copolymerizable with the monomers (a) and (b).

The proportions of the monomers a), b) and c) are selected with particular preference such that the poly(meth)acrylate has a glass transition temperature of ≤15° C. (DMA at low frequencies). For this purpose it is advantageous to select the monomers a) with a proportion of 45 to 99 wt %, the monomers b) with a proportion of 1 to 15 wt %, and the monomers c) with a proportion of 0 to 40 wt %, based in each case on the overall monomer composition of the poly(meth)acrylate.

The monomers a) are more preferably plasticizing and/or apolar monomers. Preferably, therefore, the monomers a) are selected from the group encompassing n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, 2-ethylhexyl acrylate and 2-ethylhexyl methacrylate.

The monomers b) are preferably olefinically unsaturated monomers having functional groups which are able to enter into a reaction with epoxide groups. More preferably the monomers b) each contain at least one functional group selected from the group consisting of hydroxyl, carboxyl, sulfonic acid and phosphonic acid groups, acid anhydride functions, epoxide groups, and substituted or unsubstituted amino groups.

In particular the monomers b) are selected from the group consisting of acrylic acid, methacrylic acid, itaconic acid, maleic acid, fumaric acid, crotonic acid, aconitic acid, dimethylacrylic acid, 1-acryloyloxypropionic acid, trichloroacrylic acid, vinylacetic acid, vinylphosphonic acid, maleic anhydride, 2-hydroxyethyl acrylate, 3-hydroxypropyl acrylate, 2-hydroxyethyl methacrylate, 3-hydroxypropyl methacrylate, 6-hydroxyhexyl methacrylate, allyl alcohol, glycidyl acrylate and glycidyl methacrylate.

Contemplated as monomers c) in principle are all vinylically functionalized compounds which are copolymerizable with the monomers a) and with the monomers b). Through selection and amount of the monomers c) it is possible advantageously to regulate properties of the PSA.

The monomers c) are more preferably selected from the group consisting of methyl acrylate, ethyl acrylate, n-propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, methyl 3-methoxyacrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethyl acrylate, methoxypolyethylene glycol methacrylate 350, methoxypolyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoro-propyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-penta-decafluorooctyl methacrylate, dimethylaminopropylacrylamide, dimethylaminopropylmeth-acrylamide, N-(1-methylundecyl)acrylamide, N-(n-butoxymethyl)acrylamide, N-(butoxy-methyl)methacrylamide, N-(ethoxymethyl)acrylamide, N-(n-octadecyl)acrylamide, N,N-dialkyl-substituted amides, more particularly N,N-dimethylacrylamide, N,N-dimethylmethacrylamide, N-benzylacrylamide, N-isopropylacrylamide, N-tert-butylacrylamide, N-tert-octylacrylamide, N-methylolacrylamide, N-methylolmethacrylamide; additionally acrylonitrile, methacrylonitrile; vinyl ethers such as vinyl methyl ether, ethyl vinyl ether, vinyl isobutyl ether; vinyl esters such as vinyl acetate; vinyl chloride, vinyl halides, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene, 2-polystyrene-ethyl methacrylate (molecular weight Mw of 4000 to 13 000 g/mol) and poly(methyl methacrylate)-ethyl methacrylate (Mw of 2000 to 8000 g/mol).

The monomers c) may advantageously also be selected such that they contain functional groups which support radiation-chemical crosslinking (by electron beams or UV, for example). Suitable copolymerizable photoinitiators are, for example, benzoin acrylate and acrylate-functionalized benzophenone derivatives. Monomers which support crosslinking by electron bombardment are, for example, tetrahydrofurfuryl acrylate, N-tert-butylacrylamide and allyl acrylate.

With particular preference, where the PSA comprises a plurality of poly(meth)acrylates, all poly(meth)acrylates in the PSA can be traced back to the above-described monomer composition.

More particularly the poly(meth)acrylate of the PSA can be traced back to a monomer composition consisting of acrylic acid, 2-ethylhexyl acrylate and methyl acrylate. Where the PSA comprises a plurality of poly(meth)acrylates, then more preferably all poly(meth)acrylates in the PSA can be traced back to a monomer composition consisting of acrylic acid, 2-ethylhexyl acrylate and methyl acrylate.

In particular, the poly(meth)acrylate or all poly(meth)acrylates in the PSA can be traced back to the following monomer composition:

| | |
|---|---|
| Acrylic acid | 3-15 wt % |
| Methyl acrylate | 10-35 wt % |
| 2-Ethylhexyl acrylate | 50-87 wt %, |

the proportions of the monomers adding up to 100 wt %.

The poly(meth)acrylates can be prepared by radical polymerization of the monomers in solvents, more particularly in solvents having a boiling range of 50 to 150° C., preferably of 60 to 120° C., using the customary amounts of polymerization initiators, which are in general 0.01 to 5, more particularly 0.1 to 2 wt % (based on the total weight of the monomers).

Suitable in principle are all customary initiators familiar to the skilled person. Examples of radical sources are peroxides, hydroperoxides and azo compounds, as for example dibenzoyl peroxide, cumene hydroperoxide, cyclohexanone peroxide, di-tert-butyl peroxide, cyclohexylsulfonyl acetyl peroxide, diisopropyl percarbonate, tert-butyl peroctoate, benzopinacol. One very preferred procedure uses 2,2′-azobis(2-methylbutyronitrile) or 2,2′-azobis(2-methylpropionitrile) (2,2′-azobisisobutyronitrile; AIBN) as radical initiator.

Solvents contemplated for preparing the poly(meth)acrylates include alcohols such as methanol, ethanol, n-propanol and isopropanol, n-butanol and isobutanol, preferably isopropanol and/or isobutanol, and also hydrocarbons such as toluene and, in particular, benzines from a boiling range of 60 to 120° C. Additionally it is possible to use ketones such as preferably acetone, methyl ethyl ketone, methyl isobutyl ketone, and esters such as ethyl acetate, and also mixtures of solvents of the type stated, preference being given to mixtures which include isopropanol, more particularly in amounts of 2 to 15 wt %, preferably 3 to 10 wt %, based on the solvent mixture used.

With preference, after the preparation (polymerization) of the poly(meth)acrylates, there is a concentration procedure, and the further processing of the poly(meth)acrylates is substantially solvent-free. The polymer can be concentrated in the absence of crosslinker and accelerator substances. It is also possible, however, for one of these classes of substance to be added to the polymer even prior to concentration, in which case the concentration takes place in the presence of this or these substance(s). After the concentration step, the polymers can be transferred to a compounder. Concentration and compounding may optionally also take place in the same reactor.

The weight-average molecular weight M_{w} of the poly(meth)acrylate in the PSA is preferably 20 000 to 2 000 000 g/mol, very preferably 100 000 to 1 500 000 g/mol, most preferably 150 000 to 1 000 000 g/mol. The figures for average molecular weight M_{w} and for polydispersity PD in this specification relate to the determination by gel permeation chromatography. It may be advantageous to carry out the polymerization in the presence of suitable chain transfer agents such as thiols, halogen compounds and/or alcohols in order to set the desired average molecular weight.

The poly(meth)acrylate preferably has a K value of 30 to 90, more preferably of 40 to 70, as measured in toluene (1% strength solution, 21° C.). The K value of Fikentscher is a measure of the molecular weight and the viscosity of the polymer.

Especially suitable in accordance with the invention are poly(meth)acrylates which have a narrow molecular weight distribution (polydispersity PD<4). In spite of a relatively low molecular weight on the part of the polymers, compositions based on them have particularly good shear strength after crosslinking. Moreover, the lower polydispersity makes processing from the melt easier, since the flow viscosity is lower than that of a more broadly distributed poly(meth)acrylate, for largely the same applications properties. Narrowly distributed poly(meth)acrylates may be prepared advantageously by anionic polymerization or by controlled radical polymerization methods, the latter being especially suitable. Via N-oxyls as well it is possible to prepare corresponding poly(meth)acrylates. Besides these methods, Atom Transfer Radical Polymerization (ATRP) can be employed advantageously for the synthesis of narrowly distributed polyacrylates, in which case the initiator used preferably comprises monofunctional or difunctional, secondary or tertiary halides, with the halides being abstracted using Cu, Ni, Fe, Pd, Pt, Ru, Os, Rh, Co, Ir, Ag or Au complexes.

The poly(meth)acrylate(s) in the PSA is/are preferably crosslinked. While thick layers of composition are hard to crosslink homogeneously via conventional electron beam or UV radiation treatment, owing to the rapidly decreasing radiation intensity with increasing depth of penetration, thermal crosslinking provides sufficient remedy for this situation. Preferably, therefore, the PSA is crosslinked thermally. Layers of compositions considered to be thick are more particularly those with a thickness of more than 150 μm.

The poly(meth)acrylates in the PSA are crosslinked preferably with isocyanates, more particularly with trimerized isocyanates and/or blocking-agent-free and sterically hindered isocyanates, and/or with epoxide compounds, in each case in the presence of functional groups in the polymer macromolecules that are able to react with isocyanate groups or epoxide groups, respectively.

Besides the poly(meth)acrylate(s), the PSA may also comprise one or more further polymers. These include, for example, acrylate-insoluble polymers such as polyolefins (e.g. LDPE, HDPE, polypropylene), polyolefin copolymers (e.g. ethylene-propylene copolymers), polyesters, copolyesters, polyamides, copolyamides, fluorinated polymers, polyalkylene oxides, polyvinyl alcohol, ionomers (for example, ethylene-methacrylic acid copolymers neutralized with base), cellulose acetate, polyacrylonitrile, polyvinyl chloride, thermoplastic polyurethanes, polycarbonates, ABS copolymers and polydimethylsiloxanes. Further suitable polymers are polybutadiene, polyisoprene, polychloroprene and copolymers of styrene and dienes. Additionally suitable are polymers which are inherently pressure-sensitively adhesive or which can be rendered pressure-sensitively adhesive through the addition of bond strength enhancers, examples of such polymers being poly-α-olefins such as polyoctene, polyhexene and atactic polypropylene; specific block copolymers (diblock, triblock, star-shaped block copolymers and combinations thereof), natural and synthetic rubbers, silicones and ethylene-vinyl acetate.

In one specific embodiment of the method of the invention, the PSA comprises 15 to 50 wt % of at least one synthetic rubber. Synthetic rubber is included in the PSA preferably at 20 to 40 wt %, based in each case on the total weight of the PSA.

Preferably in this embodiment at least one synthetic rubber in the PSA is a block copolymer having an A-B, A-B-A, (A-B)ₙ, (A-B)ₙX or (A-B-A)ₙX construction, in which
the blocks A independently of one another are a polymer formed by polymerization of at least one vinylaromatic;
the blocks B independently of one another are a polymer formed by polymerization of conjugated dienes having 4 to 18 C atoms and/or isobutylene, or are a partly or fully hydrogenated derivative of such a polymer;
X is the residue of a coupling reagent or initiator; and
n is an integer ≥2.

In particular in this embodiment all synthetic rubbers in the PSA are block copolymers having a construction as set out above. The PSA may therefore also comprise mixtures of different block copolymers having a construction as above.

Preferred block copolymers (vinylaromatic block copolymers) thus comprise preferably one or more rubberlike blocks B (soft blocks) and one or more glasslike blocks A (hard blocks). More preferably at least one synthetic rubber in the PSA is a block copolymer having an A-B, A-B-A, (A-B)₃X or (A-B)₄X construction, where A, B and X are as defined above. Very preferably all synthetic rubbers in the PSA are block copolymers having an A-B, A-B-A, (A-B)₃X or (A-B)₄X construction, where A, B and X are as defined above. More particularly the synthetic rubber in the PSA is a mixture of block copolymers having an A-B, A-B-A, (A-B)₃X or (A-B)₄X construction which preferably comprises at least diblock copolymers A-B and/or triblock copolymers A-B-A.

Block A is generally a glasslike block having a preferred glass transition temperature (Tg, DSC) which is above room temperature. More preferably the Tg of the glasslike block is at least 40° C., more particularly at least 60° C., very preferably at least 80° C. and most preferably at least 100° C. The proportion of vinylaromatic blocks A in the overall block copolymers is preferably 10 to 40 wt %, more preferably 20 to 33 wt %. Vinylaromatics for the construction of block A include preferably styrene, a-methylstyrene and/or other styrene derivatives. Block A may therefore be a homopolymer or copolymer. More preferably block A is a polystyrene.

The vinylaromatic block copolymer additionally preferably has a rubberlike block B or soft block having a Tg of less than room temperature. The Tg of the soft block is more preferably less than 0° C., more particularly less than −10° C., as for example less than −40° C., and very preferably less than −60° C.

Preferred conjugated dienes as monomers for the soft block B are, in particular, selected from the group consisting of butadiene, isoprene, ethylbutadiene, phenylbutadiene, piperylene, pentadiene, hexadiene, ethylhexadiene, dimethylbutadiene and the farnesene isomers, and also any desired mixtures of these monomers. Block B as well may be a homopolymer or copolymer.

The conjugated dienes as monomers for the soft block B are more preferably selected from butadiene and isoprene. For example, the soft block B is a polyisoprene, a polybutadiene or a partly or fully hydrogenated derivative of one of these two polymers, such as polybutylenebutadiene in particular; or a polymer of a mixture of butadiene and isoprene. Very preferably the block B is a polybutadiene.

The pressure-sensitive adhesive in the method of the invention is preferably a foamed PSA, at least in step b). A “foamed PSA” is a PSA which comprises a pressure-sensitive adhesive matrix material and a plurality of gas-filled cavities, thereby reducing the density of this PSA by comparison with the plain matrix material without cavities. Foaming of the matrix material of the foamed PSA may be accomplished in principle in any desired way. For example, the PSA may be foamed by means of a propellant gas which is incorporated or which is released in it. The foamed PSA preferably comprises at least partially expanded hollow microspheres. These are at least partially expanded microspheres which in their basic state are elastic and expandable and have a thermoplastic polymer shell. These spheres—in the basic state—are filled with low-boiling liquids or liquefied gas. Shell materials used are in particular polyacrylonitrile, PVDC, PVC or polyacrylates. Customary low-boiling liquids are, in particular, hydrocarbons of the lower alkanes, such as for example isobutane or isopentane, and are enclosed in the form of liquefied gas under pressure in the polymer shell. For microspheres of this kind, the term “microballoons” is also customary.

Exposure of the microballoons to heat causes the outer polymer shell to soften. At the same time, the propellant gas in liquid form within the shell undergoes transition to its gaseous state. When this occurs, the microballoons stretch irreversibly and undergo three-dimensional expansion. Expansion is at an end when the internal and external pressures match one another. Since the polymeric shell is retained, the result is a closed-cell foam.

A multiplicity of types of microballoon are available commercially, and differ essentially in their size (6 to 45 μm in diameter in the unexpanded state) and in the onset temperatures they require for expansion (75 to 220° C.). Unexpanded microballoon types are also available in the form of an aqueous dispersion with a solids fraction or microballoon fraction of around 40 to 45 wt %, and are additionally available as polymer-bound microballoons (masterbatches), in ethylene-vinyl acetate, for example, with a microballoon concentration of around 65 wt %. The microballoon dispersions and the masterbatches, like the unexpanded microballoons, are suitable as such for producing the foamed PSA.

The foamed PSA may also be generated using what are called preexpanded hollow microspheres. With this group, the expansion takes place prior to incorporation into the polymer matrix.

With preference in accordance with the invention, the foamed PSA comprises at least partially expanded hollow microspheres, irrespective of the mode of preparation and of the initial form in which the hollow microspheres are used. With particular preference at least 90% of all the cavities in the foamed PSA, formed by the hollow microspheres, have a maximum extent of 10 to 500 μm, more preferably of 15 to 200 μm.

The term “at least partially expanded hollow microspheres” is understood in accordance with the invention to mean that the hollow microspheres have undergone expansion at least to a degree such as to bring about a reduction in the density of the PSA to a technically meaningful extent by comparison with the same adhesive with the unexpanded hollow microspheres. This means that the microballoons need not necessarily have undergone complete expansion. The “at least partially expanded hollow microspheres” have preferably expanded in each case to at least twice their maximum extent in the unexpanded state.

The expression “at least partially expanded” relates to the expanded state of the individual hollow microspheres and is not intended to mean that only some of the hollow microspheres in question must have undergone (initial) expansion. If, therefore, there are “at least partially expanded hollow microspheres” and unexpanded hollow microspheres present in the PSA, this means that unexpanded (totally unexpanded, in other words having not undergone even initial expansion) hollow microspheres do not belong to the “at least partially expanded hollow microspheres”.

The foaming of the PSA within the method of the invention may proceed simultaneously with step a). This means that the foaming takes place during heating, as for example during the preparation of the PSA in an extruder, with the heat supplied and/or the heat formed as a result of the active shearing forces being utilized for the foaming, by causing microballoons to expand, for example. Consequently, even during step a), the PSA present may be partly or even completely foamed. It is also possible, however, for the foaming to be suppressed during preparation of the PSA, by means for example of a pressure that counteracts the endeavour of the composition to expand, and to take place only after release of the composition, on the basis, for example, of the associated drop in pressure. No later than in step b), however, in other words during introduction of the PSA melt into the roll nip, the PSA in this embodiment is a foamed PSA. This means that, alternatively to what was said above, the PSA may also only be foamed in the period between exit from the compounding apparatus and entry into the roll nip.

A “hotmelt adhesive layer” is a layer of an adhesive which at room temperature has no tack or only very little tack and is able only through heating to develop sufficient adhesion to a substrate to bring about an adhesive bond to that substrate. “Heating” refers customarily to exposure to a temperature in the range from about 60 to about 200° C., more particularly in accordance with the invention in the range from 120° C. to 200° C. The hotmelt adhesive layer may also be referred to, accordingly, as a “heat-activatable adhesive layer”. Fundamental suitability as a hotmelt adhesive layer is possessed by any material that has a corresponding melting range and a melt flow rate (MFR or MFI) in the range from 0.1 to 10 g/10 min (230° C., 2.16 kg loading), especially in the range from 0.2 to 5 g/10 min and more particularly in the range from 0.3 to 1.5 g/10 min.

The hotmelt adhesive layer is preferably a polyolefin layer. The polyolefin may be traced back to one or more olefin monomers. The material of the heat-activatable layer of adhesive is preferably selected from polyethylene, polypropylene, ethylene-propylene copolymers and mixtures of these polymers. With particular preference the material of the heat-activatable layer of adhesive is polypropylene (PP). More particularly, the hotmelt adhesive layer is a blown polypropylene film, also referred to as a heterophasic copolymer (Heco) or else as impact PP.

The method of the invention uses a release liner which has an outer release layer.

Customarily and also in accordance with the invention, a release liner is a carrier made of paper or of film that is furnished with an abhesive coating material (also referred to as dehesive or anti-adhesive composition) that is able to withstand the adhesion tendency of the PSA, can be separated from the latter with little effort (active release function) and is therefore also referred to as a release layer or release coating. Possibilities for use as abhesive coating materials, also called release coatings. include a great many different substances: waxes, fluorinated or partly fluorinated compounds, polycarbamates and silicones, and also various copolymers with silicone fractions.

The outer release layer of the release liner is preferably a silicone layer or a polycarbamate layer.

The silicone layer may be traced back preferably to a crosslinkable silicone system. These crosslinkable silicone systems include mixtures of crosslinking catalysts and so-called curable polysiloxanes. Silicone-containing systems for producing release coatings can be acquired commercially. The silicone release layer is typically applied in the non-crosslinked state and is crosslinked subsequently.

The silicone layer may be traced back to solvent-borne and/or solvent-free systems, preferably to a solvent-borne system.

The silicone layer may be traced back preferably to a radiation-crosslinking (UV- or electron beam-crosslinking), condensation-crosslinking or addition-crosslinking system, more preferably to an addition-crosslinking system.

Silicone-based release agents of this kind, based on addition crosslinking, can generally be cured by hydrosilylation. The formulations for producing these release agents customarily comprise the following constituents:
a linear or branched polydiorganosiloxane containing alkenyl groups,
a polyorganohydrogenosiloxane crosslinking agent, and
a hydrosilylation catalyst.

Catalysts for addition-crosslinking silicone systems (hydrosilylation catalysts) which have been found appropriate include, in particular, platinum or compounds of platinum, such as, for example, the Karstedt catalyst (a Pt(0) complex compound).

More specifically, addition-crosslinking release coatings of these kinds may comprise the following components:
a linear or branched dimethylpolysiloxane which consists of around 80 to 200 dimethylpolysiloxane units and is stopped at the chain ends with vinyldimethylsiloxy units. Typical representatives are, for example, solvent-free, addition-crosslinking silicone oils having terminal vinyl groups;
a linear or branched crosslinker which either has only methylhydrogensiloxy units in the chain (homopolymer crosslinker) or is composed of methylhydrogensiloxy and dimethylsiloxy units (copolymer crosslinker), the chain ends being satisfied either by trimethylsiloxy groups or dimethylhydrogensiloxy groups; typical representatives of this class of product are, for example, hydrogenpolysiloxanes with a high reactive Si—H content, such as the V24, V90 or V06 crosslinkers available commercially from Wacker-Chemie GmbH;
a silicone MQ resin which as M unit, besides the trimethylsiloxy units customarily used, also possesses vinyldimethylsiloxy units;
a silicone-soluble platinum catalyst such as, for example, a platinum-divinyltetramethyldisiloxane complex, customarily referred to as the Karstedt complex.

One unwanted property of addition-crosslinking silicone systems, however, is their sensitivity to catalyst poisons, such as to heavy metal compounds, sulfur compounds and nitrogen compounds, for example (in this regard cf. “Chemische Technik, Prozesse und Produkte” by R. Dittmeyer et al., Volume 5, 5th Edition, Wiley-VCH, Weinheim, Germany, 2005, Section 6-5.3.2, page 1142). Generally speaking, electron donors may be considered to be platinum poisons (A. Colas, Silicone Chemistry Overview, Technical Paper, Dow Corning). Accordingly, phosphorus compounds such as phosphines and phosphites are also considered to be platinum poisons. As a result of the presence of catalyst poisons, the crosslinking reaction between the various constituents of a silicone release agent no longer takes place, or takes place only to a small extent. In the production of anti-adhesive silicone coatings, therefore, the general rule is to strictly avoid the presence of catalyst poisons, and especially of platinum poisons.

Particular versions of silicone release systems are polysiloxane block copolymers, with a urea block, for example, of the kind available from Wacker under the trade name “Geniomer”, or fluorosilicone release systems, which are used in particular with adhesive tapes comprising silicone adhesives.

Furthermore, photoactive catalysts, referred to as photoinitiators, can also be used, in combination with UV-curable, cationically crosslinking, epoxide-based and/or vinyl ether-based siloxanes and/or with UV-curable, radically crosslinking siloxanes such as acrylate-modified siloxanes, for instance. Also possible is the use of electron-beam-curable silicone acrylates.

Photopolymerisable organopolysiloxane compositions can also be used as a basis for the silicone release layer. Examples include compositions which are crosslinked in the presence of a photosensitizer through the reaction between organopolysiloxanes having hydrocarbon radicals substituted by (meth)acrylate groups and bonded directly to silicon atoms (see EP 0 168 713 B1 or DE 38 20 294 C1, for example). Likewise usable are compositions wherein the crosslinking reaction takes place between organopolysiloxanes having hydrocarbon radicals substituted by mercapto groups and bonded directly to silicon atoms, and organopolysiloxanes having vinyl groups bonded directly to silicon atoms, in the presence of a photosensitizer. Such compositions are described in U.S. Pat. No. 4,725,630, for example.

When using organopolysiloxane compositions, described for example in DE 33 16 166 C1, that have hydrocarbon radicals substituted by epoxy groups and bonded directly to silicon atoms, the crosslinking reaction is induced by release of a catalytic amount of acid, which is obtained by photodecomposition of added onium salt catalysts. Other organopolysiloxane compositions curable by a cationic mechanism are materials which have propenyloxysiloxane end groups, for example.

Depending on the nature of the PSA for coating, the silicone layer may also include further additions, with examples being stabilizers or flow control assistants.

In one particularly preferred embodiment of the method of the invention, the outer release layer is a pressure-sensitive adhesive Hkm which comprises
at least one silicone PSA Si-Hkm, which is obtainable from a composition comprising
   at least one polysiloxane having two or more Si-alkenyl groups,
   at least one substance having two or more Si—H groups,
   at least one hydrosilylation catalyst, and also
   at least one silicone resin;
where the peel adhesion of the PSA Hkm increases with increasing weight per unit area.

With particular preference the outer release layer is a pressure-sensitive adhesive Hkm comprising
at least one silicone PSA Si-Hkm, which is obtainable from a composition comprising
   at least one polysiloxane having two or more Si-alkenyl groups,
   at least one substance having two or more Si—H groups,
   at least one hydrosilylation catalyst, and also
   at least one silicone resin;
where the peel adhesion of the PSA Hkm increases with increasing weight per unit area and the release force of the release liner with respect to an arbitrary PSA lying on the outer release layer is 2 to 100 cN/cm. In particular in this case the release force of the release liner with respect to an adhesive tape which comprises a foamed, polyacrylate-based layer, as for example with respect to the adhesive tape Tesa® ACXplus 7812, is 2 to 100 cN/cm. All in all it has emerged that, if the outer release layer is a PSA Hkm, then very good, and in particular not insufficient, release forces are achieved with respect to low-mobility, polyacrylate-based PSAs.

The polysiloxane containing two or more Si-alkenyl groups in the silicone PSA Si-Hkm is preferably a polydiorganosiloxane containing two or more Si-vinyl groups, more particularly a polydimethylsiloxane containing two or more Si-vinyl groups.

The substance containing Si—H groups in the silicone PSA Si-Hkm is preferably a linear or branched crosslinker which is composed of methylhydrogensiloxy and dimethylsiloxy units, the chain ends being saturated either with trimethylsiloxy groups or dimethylhydrogensiloxy groups.

The hydrosilylation catalyst is preferably a customary Pt-based catalyst for the addition reaction of the Si—H groups onto the alkenyl groups. It is included preferably at 50 ppm to 1000 ppm in the PSA Hkm.

The silicone resin of the PSA Hkm is preferably an MQ silicone resin. The silicone resin preferably comprises Si-bonded alkyl and/or alkenyl radicals, more particularly methyl and/or vinyl radicals, very preferably methyl radicals, on the silicon atom valencies not assigned to Si—O—Si bridges.

The molar ratio of Si—H groups to the Si-alkenyl groups in the polysiloxane of the silicone PSA Si-Hkm is preferably 1.3:1 to 7:1.

When the PSA Hkm described is used as an outer release layer of the release liner in the method of the invention, the peel adhesion and, associated therewith, the release behaviour of the release layer can be controlled advantageously by way of the layer thickness of the applied PSA Hkm and also by way of the fraction of the silicone resin. An increasing coatweight of the PSA Hkm results in an increase in the peel adhesion and hence an increase in the release forces needed in order to remove the release liner from the adhesive covered with it.

The polycarbamate of the polycarbamate layer is preferably a polyvinylcarbamate whose N atoms are substituted by a C₁₂-C₂₄ alkyl radical, more particularly by a C₁₂-C₁₈ alkyl radical. Such polycarbamates are accessible through polymerization of vinyl acetate, subsequent hydrolysis to give polyvinyl alcohol, and reaction thereof with corresponding alkyl isocyanates.

With particular preference the polycarbamate of the polycarbamate layer is a polyvinylstearylcarbamate. The polycarbamate layer as well may contain further additions, depending on the nature of the PSA for coating.

With particular preference the release liner of the method of the invention is a release liner which comprises
an external silicone release layer (SR);
a ply (POL) which in each of its layers, to an extent in total of at least 50 wt %, based in each case on the total weight of the layer, contains one or more polyolefins,
where the ply (POL) contains polypropylene to an extent of at least 60 wt %, based on the total weight of the ply (POL); and
   an external layer (PER) which contains polyethylene to an extent of at least 80 wt %, based on the total weight of the layer (PER),
where the layer (PER) is joined by an adhesive to the subsequent layer in the construction of the release liner. Release liners of this kind have proved to have particular thermal stability on being coated with the PSA melt, and hence no deleterious changes in shape of the release liner were observed even with very hot melts. On the side of liners of the invention that was coated with the layer (PER), it was possible to attach one or more grip tabs, made from a PET/PE composite or an aluminium/PET/PE composite, for example, by thermal welding. Subsequently, the liner was readily removable from the PSA without detriment to the assembly formed of grip tab and liner or to the layer composite of the liner.

The silicone release layer (SR) may have all of the manifestations of a silicone-based outer release layer as described above.

The particularly preferred release liner includes a ply (POL) which contains polypropylene to an extent of at least 60 wt %, based on the total weight of the ply (POL). A “ply” refers to a single-layer or multi-layer part of the layer construction of the release liner of the invention, and in the case of a multi-layer ply, the layers of this ply follow one another directly. In each of its layers, the ply (POL) contains, to a total of at least 50 wt %, one or more polyolefins. In accordance with the remarks above, the expression “containing in each of its layers” also embraces a single-layer ply and should in that case be understood to mean “containing in the layer”.

The ply (POL) preferably comprises a layer (PPK) which contains polypropylene to an extent of at least 60 wt %, more preferably at least 65 wt %, more particularly at least 70 wt %, as for example at least 75 wt %, based in each case on the total weight of the layer. It has emerged that polypropylene contents of this kind are beneficial to the thermal stability of the layer (PPK), of the overall ply (POL) and of the release liner of the invention. With particular preference the layer (PPK) consists of polypropylene which has been blended at no more than 15 wt %, more preferably at no more than 12 wt %, with rubber and with no more than 15 wt %, more preferably no more than 10 wt %, with colorants.

The layer (PPK) is preferably a polypropylene film. The polypropylene film may be coloured with pigments or organic dye, added in the form of a colour masterbatch. As already described above, the polypropylene film preferably has a maximum rubber content of 15 wt %, more preferably 12 wt %, based in each case on the total weight of the polypropylene film. More particularly the polypropylene film consists of a heterophasic polypropylene copolymer having a rubber fraction of 15 wt % at most and a colorant fraction of 15 wt % at most, more preferably having a rubber fraction of 12 wt % at most and a colorant fraction of 10 wt % at most. The rubber is preferably an EPM rubber.

With particular preference the layer (PPK) is a polypropylene film having a melting temperature of at least 160° C. The polypropylene of the layer (PPK) is preferably what is called a heterophasic PP copolymer (HECO PP, impact PP). A copolymer of this kind has a high temperature stability in particular. The temperature stability, resulting from the melting temperature, is comparable with that of pure homo-PP. A heterophasic PP copolymer, however, is notable for greater flexibility and also lower strength and less brittleness. This is achieved through copolymerization of homo-PP with an EP rubber.

In one embodiment the ply (POL) comprises a layer (PPK) and a polyolefin layer (POK) which includes at least 25 wt %, more preferably at least 30 wt %, more particularly at least 35 wt % of polyethylene and also at least 20 wt %, more preferably at least 30 wt %, more particularly at least 50 wt % of polypropylene, based in each case on the total weight of the polyolefin layer (POK). With very particular preference the polyolefin layer (POK) contains at least 70 wt %, more preferably at least 80 wt %, more particularly at least 90 wt %, based in each case on the total weight of the polyolefin layer (POK), of a mixture of polyethylene and polypropylene in a PP/PE weight ratio of 40/60 to 80/20, more particularly of 50/50 to 70/30, as for example of 55/45 to 65/35. With particular preference the polyolefin layer (POK) consists of such a mixture of polypropylene and polyethylene.

In the present text, the terms “polyolefin layer (POK)” and “layer (POK)” refer to the same layer.

With particular preference the polypropylene of the polyolefin layer (POK) is a heterophasic PP copolymer, e.g. an impact polypropylene. The polyethylene of the polyolefin layer (POK) is preferably an mPE, in particular an LLDPE. Via the blend ratio it is possible advantageously to fine-tune the mechanical properties of an assembly composed in each case of one or more layers (PPK) and (POK), and more particularly the strength of such an assembly. The mechanical properties of this assembly become apparent in particular when the assembly is coated with the silicone release composition intended for forming the layer (SR) and/or with the composition intended for forming the layer (PER). This is manifested in a particularly positive way during application of the release liner of the invention, especially when it is processed mechanically and when it is used, when an adhesive tape lined therewith is bonded around curves. With particular preference the release liner, or at least the assembly described, is highly stable on extension and in this way counteracts stretching or overstretching of the adhesive tape in the course of its application and processing. It is notable that a composite form from the layers (PPK) and (POK) consequently achieves a particularly good balance between the two opposing properties of stretchability and stretch resistance.

In one embodiment, the layer (POL) comprises a layer (PPK) on either side, top and bottom, of which there is a layer (POK) in direct contact with the layer (PPK). The two layers (POK) in this case consist preferably of identical material. Preferably, therefore, the two layers (POK) and the layer (PPK) are present in the form of a layer composite such that the layer (PPK) forms a central layer with one layer (POK) each disposed on its top and bottom sides, with each of the layers (POK) being in direct contact with the layer (PPK). This three-layer assembly is more preferably in the form of a coextruded film. The assembly is produced in particular as a blown film, but may also be produced as flat film in a flat film process.

In a further embodiment, the layer (POL) comprises a layer (POK) which on either side, top and bottom, bears a layer (PPK) in direct contact with the layer (POK). The two layers (PPK) in this case consist preferably of identical material. This three-layer assembly as well is present with particular preference in the form of coextruded film. The assembly is produced in particular in the form of blown film, but may also be produced as flat film in a flat film process.

In particular, in both embodiments, in other words in the (POK)-(PPK)-(POK) construction and in the (PPK)-(POK)-(PPK) construction, the outer layers in each case have an identical layer thickness, disregarding deviations arising from production and/or process. Symmetrical constructions of this kind, in contrast to asymmetric constructions, do not exhibit any tendency to roll up, as is frequently observed with the latter constructions particularly under temperature loading.

The raw materials for the production of the layers (PPK) and (POK), and hence in particular the layer (PPK) and/or the layers (PPK) and (POK), preferably contain, on a weight basis, less than 1000 ppm of catalyst poisons, in relation to the hydrosilylation catalyst of the layer (SR). Otherwise there may be disruptions to silicone crosslinking, as a result of which the release properties of the outer release layer may be disrupted. Relevant catalyst poisons include, in particular, phosphorus-containing and nitrogen-containing compounds, examples being phosphite stabilizers such as Irgafos 168 or Irgafos TNPP, lubricants or antistats having amide or amine functionalities, such as erucamide, for example. With particular preference the raw materials for the production of the layer (PPK) or of the layers (PPK) and (POK), and hence in particular the layer (PPK) or the layers (PPK) and (POK), are free from catalyst poisons affecting the hydrosilylation catalyst of the layer (SR).

The thickness of what is in each case the central layer in the (POK)-(PPK)-(POK) or (PPK)-(POK)-(PPK) construction is preferably in each case 40 to 80 μm, more preferably 50 to 70 μm, especially 55 to 65 μm, very preferably 57 to 63 μm. The thickness of the respective outer layers in the (POK)-(PPK)-(POK) or (PPK)-(POK)-(PPK) construction is in each case independently preferably 10 to 30 μm, more particularly 15 to 25 μm, very preferably 17 to 23 μm. The ratio of the layer thicknesses of the respective central layer and one of the outer layers in the (POK)-(PPK)-(POK) or (PPK)-(POK)-(PPK) construction is preferably 10:3 to 10:1.

The particularly preferred liner further comprises at least one external layer (PER) containing at least 80 wt % of polyethylene. The layer (PER) preferably contains polyethylene to an extent of at least 90 wt %, more preferably at least 95 wt %, more particularly at least 98 wt %, as for example at least 99 wt %, based in each case on the total weight of the layer (PER). With very particular preference the layer (PER) consists of polyethylene. The layer (PER) is more particularly a polyethylene film. The layer (PER) in this case may also consist of a blend or a mixture of different polymers.

The polyethylene of the layer (PER) is preferably a low-density PE (LDPE). With particular preference the external layer (PER) consists of LDPE, and more particularly the layer (PER) is an LDPE film. The layer (PER) in particular is an LDPE film having a thickness of 10 to 45 μm, very preferably having a thickness of 20 to 40 μm, as for example of 24 to 33 μm.

The polyethylene film of the layer (PER) is preferably a blown film. The polyethylene film (PER) may also be a multi-layer film, as for example a three-layer film. In the latter case, the film consists of three PE layers.

The LDPE of the layer (PER) preferably has a density of less than 0.925 g/cm3, more particularly of less than 0.92 g/cm3. A layer (PER) equipped in this way has particularly low release forces or unwind forces relative to PSAs; there is therefore no need for an additional silicone release coating. The layer (PER) consequently also has particularly high heat resistance. An advantageous consequence of this is the possibility of applying a grip aid to the layer (PER) by means of an efficient heat-sealing operation. Preferably, therefore, a grip aid is applied to at least a part of the layer (PER).

The layer (PER) of the particularly preferred release liner is joined by an adhesive to the subsequent layer in the construction of the release liner. It has emerged that by this means the resulting composite adhesion is improved substantially by comparison with alternative methods for incorporating the layer (PER) into the layer assembly of the release liner. Alternative methods for incorporating the layer (PER) into the layer assembly of the release liner are, for example, coextrusion of the layer (PER) with the adjacent layer or layers, or extrusion coating.

The adhesive may be regarded as a laminating adhesive and is in principle not restricted in terms of the spectrum of adhesives that can be used, provided that the layer (PER) and the subsequent layer in the construction of the liner can be joined by this adhesive in a manner that is in accordance with the requirements. The layer (PER) is preferably joined to a layer (PPK) or (POK) by an adhesive. In particular, the layer (PER) is joined to one of the respective outer layers in the above-described (POK)-(PPK)-(POK) or (PPK)-(POK)-(PPK) construction of the ply (POL) by means of an adhesive.

Suitable adhesive includes in principle all of the solvent-borne, solvent-free and aqueous adhesives known in the prior art, with a different polymer basis, examples being polyurethane, polyester, polyethylene or ethylene-vinyl acetate. The adhesive is preferably a polyurethane-based adhesive. “Polyurethane-based” here means that a polyurethane or the entirety of two or more polyurethanes makes up the main constituent of the polymer composition of this adhesive, in other words accounting for the largest fraction of the polymer composition.

Solvent-free polyurethane adhesives may take the form of one- or two-component systems. Further differences may result from the structure of the polyurethane and from the nature of the crosslinking. The following polymers are frequently preferred:
1-component system: prepolymers of low molecular weight, NCO-terminated, moisture-crosslinking;
2-component system: prepolymers having NCO end groups+polyols.

Aromatic isocyanates are frequently used, but present problems in food contact, where it is possible for primary aromatic amines to be formed. Occasionally, therefore, and especially when UV stability is required, as well, aliphatic isocyanates are employed. In principle, better adhesion and more rapid curing are achievable with aromatic isocyanates.

Polyether-polyurethanes usually have a greater temperature stability than polyester-polyurethanes. Often, however, the polyol component consists of a mixture of polyester polyols and polyether polyols. The use of polyols with a functionalization of three or more is also frequent, in order to generate additional crosslinking effects, an effect of which in turn is often a greater temperature stability.

The adhesive in the described embodiment of the invention is preferably a polyether-polyurethane-based adhesive based on a solvent-free 2-component system. It has emerged as being advantageous to allow an assembly produced using adhesive and composed of the layers (PER) and (PPK) and/or (PER) and (POK) to rest for a number of days in order to await the attainment of the full composite strength. It has also emerged as being advantageous to subject those areas that are to be bonded to one another to a corona pretreatment prior to bonding.

A particular advantage of the bonding of the layer (PPK) and/or (POK) to the layer (PER) lies in the significantly higher bond strength relative to the coextrusion of both layers. Coextrusion of these layers has proved to be possible, but resulted in lower bond strengths. A certain improvement in the bond strength may be achieved by modifying one or both layers with what are called adhesion promoters, examples being polymers modified with maleic acid, or by using an additional adhesion promoter layer, the so-called tie layer. In spite of these measures, the composite adhesion for the application is too low and so delamination of the layer (PER) is observed when an attempt is made to peel the liner from the adhesive tape by means of a tab.

The method of the invention includes the heating of the PSA. Heating preferably takes place together with the production or compounding of the PSA. The method for producing the PSA is preferably a hotmelt method, meaning that the composition is converted into, and processed in, the melt state.

A method for producing the PSA may first comprise concentrating the dispersion or solution resulting from polymer preparation. Concentration of the polymer may take place in the absence of crosslinker and accelerator substances. It is, however, also possible for at most one of these substances to be added to the polymer even before concentration, meaning that concentration then takes place in the presence of this or these substance(s). Concentration preferably takes place in an extruder designed for the purpose.

The further production of the PSA also takes place preferably in one or more extruders. These extruders may possess specific metering stations, as for example solids metering facilities for introducing solids, or side feeders for introducing concentrated and possibly already melted polymer. In particular versions of the method, it is also possible for concentration and compounding to take place in the same reactor.

During processing, the polymers are present in the compounder, more particularly in the extruder, preferably in the melt, either since they are actually introduced in the melt state or because they are heated to a melt in the compounder. The polymers are advantageously maintained in the melt by heating in the compounder.

Where accelerator substances are used for crosslinking poly(meth)acrylate, they are preferably not added to the polymers until shortly before further processing, more particularly before coating or other shaping. The time window for the addition prior to coating is guided in particular by the available pot life, in other words the working time in the melt within which the properties of the resultant product are not adversely altered.

The crosslinkers, epoxides for example, and the accelerators may also both be added to the composition shortly before further processing, in other words, advantageously, in the phase as set out above for the accelerators. For this purpose it is advantageous if crosslinker and accelerator are introduced simultaneously into the process at one and the same location, optionally in the form of an epoxide-accelerator blend. In principle it is also possible to transpose the times and/or locations of addition for crosslinker and accelerator in the versions set out above, meaning that the accelerator may be added before the crosslinker substances.

The latest point in time at which the PSA is present in melt form is when it is introduced into the roll nip. The PSA is preferably already in melt form at the end of its preparation process. The PSA is preferably introduced into the roll nip via a nozzle.

In accordance with the invention the hotmelt adhesive layer is guided in such a way that it lies on one of the rolls, so that one of its sides faces away from the roll surface and therefore comes into contact with the PSA melt when the latter is introduced into the roll nip.

The hotmelt adhesive layer surface facing away from the roll surface—and therefore intended for contact with the PSA—is preferably subjected to a treatment for increasing the adhesion to the PSA before it is contacted with the latter. In particular, before being contacted with the PSA, the surface of the hotmelt adhesive layer that faces away from the roll surface is treated with a corona, more preferably with an inert-gas corona, or with a plasma, or else a primer is applied to the surface.

The release liner is guided via the second roll, in such a way that its outer release layer faces away from the roll surface.

After the PSA melt has been introduced into the roll nip, and therefore between the outer release layer of the release liner and the hotmelt adhesive layer, rotation of the rolls produces the contacting of the layers involved, as already outlined, and—after travel through the roll nip—the subsequent cooling of the layers of the assembly made up of hotmelt adhesive layer—pressure-sensitive adhesive—release liner. The release liner is a permanent liner (“customer liner”), and may therefore remain on the PSA until the adhesive sealing tape is applied. Conversely, a temporary carrier in the further processing operation, as for example during conversion of the adhesive tape, would be removed from the layer of adhesive and optionally replaced by a different liner.

It is preferably the case that at least one of the rolls of the roll applicator forming the roll nip is provided with an anti-adhesive roll surface. All of the rolls of the roll applicator that come into contact with the PSA are preferably furnished anti-adhesively. An anti-adhesive roll surface used with preference is a composite steel-ceramic-silicone material. Roll surfaces of this kind are resistant to thermal and mechanical loads.

It has emerged as being particularly advantageous if the roll surfaces used have a surface structure, more particularly of a kind such that the surface does not make full contact with the layer of composition being processed, but instead that the contact area is lower by comparison with a smooth roll. Particularly favourable are structured rolls such as metal gravure rolls, examples being steel gravure rolls.

The resulting adhesive sealing tape is used preferably for processing in vehicle construction. A further subject of the invention is the use of an adhesive sealing tape produced by a method of the invention for producing a seal in a vehicle. Sealing in this case takes place preferably with the hotmelt adhesive layer onto an ethylene-propylene-diene terpolymer (EPDM), more particularly onto a thermoplastic olefin (TPO) or a thermoplastic vulcanizate (TPV). The surfaces of the TPO or TPV and the hotmelt adhesive side of the adhesive sealing tape are preferably heated by means of hot air or IR emitters until their melting ranges have been reached; subsequently, the two parts are sealed to one another using laminating rolls. An adhesive sealing tape produced by a method of the invention is used with particular preference for producing a seal in the door or tailgate region or for producing a seal or a profile in the region of the windscreen of a car.

An adhesive sealing tape produced by a method of the invention can also be used for producing a seal in the window region of buildings.

### EXAMPLE

1. Preparing the Pressure-Sensitive Adhesive

Preparing Polyacrylate Base Polymer:

A reactor conventional for radical polymerizations was filled with 72.0 kg of 2-ethylhexyl acrylate, 20.0 kg of methyl acrylate, 8.0 kg of acrylic acid and 66.6 kg of acetone/isopropanol (94:6). After nitrogen gas had been passed through the reactor for 45 minutes with stirring, the reactor was heated up to 58° C. and 50 g of AIBN, in solution in 500 g of acetone, were added. The external heating bath was then heated to 75° C. and the reaction was carried out constantly at this external temperature. After 1 hour a further 50 g of AIBN, in solution in 500 g of acetone, were added, and after 4 hours the batch was diluted with 10 kg of acetone/isopropanol mixture (94:6).

After 5 hours and again after 7 hours, initiation was repeated in each case with 150 g of bis(4-tert-butylcyclohexyl) peroxydicarbonate, in each case in solution in 500 g of acetone. After a reaction time of 22 hours, the polymerization was discontinued and the batch was cooled to room temperature. The product had a solids content of 55.8% and was dried. The resulting polyacrylate had a K value of 58.9, an average molecular weight Mw of 748 000 g/mol, a polydispersity D (Mw/Mn) of 8.9 and a static glass transition temperature Tg of −35.2° C.

Preparation of the PSA:

In a planetary roller extruder, the synthetic rubber Kraton D1118 in pellet form was melted via a solids metering facility. A microballoon paste (50% Expancel 051DU40 in Ethomeen C25) was added. Via a side feeder, the polyacrylate base polymer, having undergone preliminary melting in a single-screw extruder, was introduced and a terpene-phenolic resin (Dertophen DT105) was metered in. Added to the mixture were a crosslinker solution (Polypox R16 15% in Rheofos RDP) a an accelerator solution (15% Epicure 925 in Rheofos RDP). The melt was thoroughly mixed, and the microballoons expanded in the process. This gave a foamed PSA having a density of 550 kg/m³. The composition was 48% polyacrylate, 25% Kraton D1118, 18% Dertophen DT105, 4% crosslinker/accelerator solution (crosslinker: accelerator=1:1), 5% microballoon paste (figures in wt %).

2. Production of the Adhesive Sealing Tape

2.1 Release Liner Used

The release liner used was a double-sidedly siliconized (solvent-free, addition-crosslinked silicone system with platinum catalyst) PET film 75 μm thick.

2.2 Hotmelt Adhesive Used

A blown polypropylene film 40 μm thick, Borealis BA110CF (heterophasic copolymer with an MFI of 0.85 g/10 min), was used, and had been subjected by the manufacturer to off-line corona pretreatment.

2.3 Laminating Operation

The PSA was guided via a nozzle into a calender nip, the temperature of the adhesive being 140-150° C. In the calender nip, the PSA was coated out between the release liner, supplied from above, and the hotmelt adhesive layer, supplied from below. The width of the calender nip was 800 μm. The two calender rolls were each heated to 90° C., and the web speed was 5 m/min.

The shaped web with the layer sequence of hotmelt sealing film—pressure-sensitive adhesive layer—release liner was subsequently passed via a chill roll (temperature 8° C.) and further through a cooling channel (room temperature), and was then wound up in the form of a completed adhesive sealing tape. The temperature of the product during winding corresponded to the ambient temperature.

3. Test/Results

The adhesive sealing tape for testing was slit to a width of 8.5 mm.

The hotmelt adhesive layer of the adhesive sealing tape and an EPDM profile were superficially melted by IR radiation and in this state were assembled by means of laminating rolls in a laminating nip. The resultant assembly was cooled for a number of minutes to room temperature.

The release liner was then removed from the PSA layer of the adhesive sealing tape; it was removable from the PSA with an expenditure of force customary for this operation. Immediately thereafter, an etched aluminium foil (127 μm in thickness) was applied to the layer of PSA, by pressing the film down five times back and forth using a 2 kg roller.

After a resting time of 24 hours, the resulting adhesive assembly was pulled apart by hand vertically with respect to the plane of the bond; without exception, cohesive fracture within the foamed PSA layer was observed.

1. A method for producing an adhesive sealing tape covered with a release liner, comprising
a) heating a pressure-sensitive adhesive to obtain the pressure-sensitive adhesive present in melt form;
b) producing a composite in a roll nip so that
(i) a hotmelt adhesive layer is lying on one roll,
(ii) a release liner is lying on another roll, the release liner having an outer release layer, said outer release layer pointing away from a roll surface,
(iii) the pressure-sensitive adhesive melt is introduced into the roll nip and
(iv) by rotation of the rolls, contacting of the layers and cooling, a composite is obtained with the following sequence: the hotmelt adhesive layer, the pressure-sensitive adhesive, then the release liner,
wherein the release liner remains on the pressure-sensitive adhesive until the adhesive sealing tape is applied.

2. The method according to claim 1, wherein the hotmelt adhesive layer is a polyolefin layer.

3. The method according to claim 1, wherein the pressure-sensitive adhesive in step b) is a foamed pressure-sensitive adhesive.

4. The method according to claim 1, wherein the pressure-sensitive adhesive comprises at least 30 wt % poly(meth)acrylate, based on the total weight of the pressure-sensitive adhesive.

5. The method according to claim 1, wherein the outer release layer of the release liner is a silicone layer or a polycarbamate layer.

6. The method according to claim 1, wherein the release liner comprises a polyolefin carrier layer.

7. A method of producing a seal in a vehicle comprising a step of applying the adhesive sealing tape produced by the method according to claim 1 to a substrate.
